(19) United States
(12) Patent Application Publication
(10) Pub. No.: US 2003/0185528 A1
(43) Pub. Date: Oct. 2, 2003

(54) Optical fiber cable and a method of fabricating it

(75) Inventor: Vincent Bourget, Marly Le Roi (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/397,203

(22) Filed: Mar. 27, 2003

(30) Foreign Application Priority Data
Apr. 2, 2002 (FR) 02 04 085

(51) Int. Cl. G02B 6/44

(52) U.S. Cl. 385/113

(57) ABSTRACT

An optical fiber cable includes a sheath, optical fibers accommodated in the sheath, and a substantially annular strength member radially between the optical fibers and the sheath. The strength member has a slot extending in its general longitudinal direction. The slot is delimited by separated or contiguous edges of the strength member and provides access to the optical fibers accommodated in the strength member.

### CROSS-REFERENCE TO RELATED APPLICATIONS

This application is based on French Patent Application No. 02 04 085 filed Apr. 2, 2002, the disclosure of which is hereby incorporated by reference thereto in its entirety, and the priority of which is hereby claimed under 35 U.S.C. §119.

### BACKGROUND OF THE INVENTION

1. Field of the Invention

The present invention relates to an optical fiber cable and a method of fabricating it.

2. Description of the prior art

Optical fiber cables, sometimes referred to hereinafter as optical cables, can have structures of different types.

U.S. Pat. No. 6,091,871 describes a prior art optical fiber cable comprising a sheath accommodating optical fibers and a substantially annular strength member interleaved radially between the optical fibers and the sheath.

The optical cable described in U.S. Pat. No. 6,091,871 is a uni-tube cable. This type of optical cable contains a relatively small number of optical fibers housed in a single tube covered with the sheath. Filamentary members providing strengthening in traction, usually referred to as strength members, are buried in a wall delimiting the sheath. The presence of the strength members limits the possibilities of reducing the diameter of the sheath.

An object of the invention is to propose an optical cable containing a relatively small number of optical fibers (for example about twelve optical fibers) and having as small a diameter as possible, whilst retaining the features usually required of this type of cable, namely good resistance to crushing and traction and low contraction at low temperatures.

### SUMMARY OF THE INVENTION

To this end, the invention provides an optical fiber cable including a sheath, optical fibers accommodated in the sheath, and a substantially annular strength member radially between the optical fibers and the sheath, which strength member has a slot extending in its general longitudinal direction, delimited by separated or contiguous edges of the strength member, and providing access to the optical fibers accommodated in the strength member.

Different embodiments of the optical cable have the following features:

the edges of the strength member delimiting the access slot are separated by a distance greater than the diameter of an optical fiber;

the strength member comprises two longitudinal half-members each of which has edges in contact with the other half-member, the edges in contact of the half-members forming contiguous edges delimiting two optical fiber access slots;

the optical cable includes means for holding the two half-members together and adapted to be torn or cut;

the means for holding the two half-members together comprise a tie wrapped around the strength member;

the strength member is made from a synthetic material;

the synthetic material of the strength member is reinforced with fibers, for example glass fibers, and the synthetic material is a material known as fiber reinforced plastic (FRP) or glassfiber reinforced plastic (GRP);

the synthetic material of the strength member is a thermoplastics material;

the strength member is made of metal, for example steel;

the edges of the strength member delimiting the slot are straight;

the edges of the strength member delimiting the access slot have an SZ shape;

a filler material, for example a gel or a powder, is accommodated in the strength member.

The invention also provides a method of fabricating an optical cable as defined above, wherein:

the strength member is fabricated,

the optical fibers are accommodated in the strength member to form an optical assembly comprising the strength member and the optical fibers, and

the sheath is extruded around the optical assembly.

According to another feature of the invention, the filler material is placed in the strength member before extruding the sheath.

The invention will be better understood after reading the following description, which is given by way of example only and with reference to the accompanying drawings.

### BRIEF DESCRIPTION OF THE DRAWINGS

FIG. 1 is a view in cross section of a first embodiment of an optical fiber cable according to the invention.

FIG. 2 is a view similar to FIG. 1 of a second embodiment of an optical fiber cable according to the invention.

FIG. 3 is a side view of the optical cable shown in FIG. 2.

### DETAILED DESCRIPTION OF THE PREFERRED EMBODIMENTS

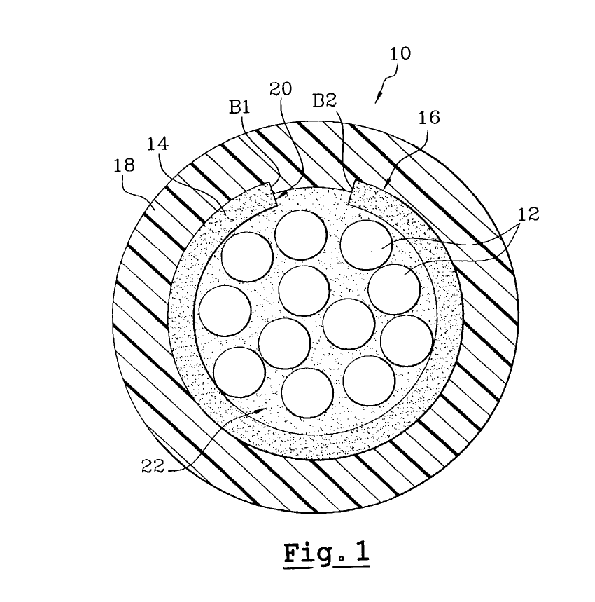

FIG. 1 shows a first embodiment of an optical fiber cable according to the invention.

The optical cable 10 includes a bundle of conventional optical fibers 12 accommodated in a substantially annular strength member 14. The assembly comprising the strength member 14 and the optical fibers 12 is referred to hereinafter as an optical assembly 16.

The optical assembly 16 is covered with a sheath 18. The strength member 14 is therefore radially between the optical fibers 12 and the sheath 18.

The strength member 14 is preferably the only strength member of the cable 10.

The optical cable 10 includes a relatively small number of optical fibers 12, for example about twelve fibers.

In the embodiments shown in the figures, the strength member 14 is made from a synthetic material, if necessary reinforced with fibers, in particular glass fibers, to limit contraction of the optical cable 10 at low temperatures. The synthetic material can be a material known as fiber-reinforced plastic (FRP) or a material known as glassfiber-reinforced plastic (GRP). The synthetic material can equally well be a thermoplastics material reinforced with glass fibers, in particular in the form of wicks.

Alternatively, the strength member 14 can be made of metal, in particular of steel, for example by rolling sheet steel.

The sheath 18 is made from a conventional synthetic material, for example linear low density polyethylene (LLDPE) or high density polyethylene (HDPE).

According to the invention, the strength member 14 has a slot 20 extending in its general longitudinal direction. The slot 20 provides easy access to the optical fibers 12 accommodated in the strength member 14.

In the first embodiment of the invention, the slot 20 is delimited by edges B1, B2 of the strength member 14, the distance between which is relatively small but greater than the diameter of an optical fiber 12.

It will also be noted that, in the first embodiment of the invention, the edges B1, B2 of the strength member 14 delimiting the slot 20 are straight. Alternatively, the edges B1, B2 of the strength member 14 delimiting the slot 20 could have the SZ (complex spiral) shape known in the art.

The strength member 14 preferably accommodates conventional filler material 22, for example a gel or a powder, which contributes to sealing the optical cable 10 and to protecting the optical fibers 12 when the sheath 18 is extruded.

The optical cable 10 is preferably fabricated in the following manner.

First of all, the strength member 14 is fabricated, for example by extrusion if the strength member 14 is made of a synthetic material or by bending sheet metal if the strength member 14 is made of metal.

Then, before extruding the sheath 18, the optical fibers 12 are inserted into the strength member 14 to form the optical assembly 16, through the slot 20.

The filler material 22 is introduced into the strength member 14 before extruding the sheath 18, and preferably concomitantly with the insertion of the optical fibers 12 into the strength member 14.

If necessary, the optical assembly 16 can be fabricated on an installation separate from the installation in which the sheath 18 is extruded around the optical assembly 16. This enables fabrication of the optical assembly 16 to be subcontracted.

The strength member 14 confers on the optical cable 10 good resistance to crushing and traction and guarantees little contraction of the optical cable 10 at low temperatures.

Consequently, to obtain the above features, it is not necessary to accommodate in the sheath 18 strength members such as strength members or glass fibers.

Because of this the sheath 18 can be extruded around the optical assembly 16 quickly and the thickness of the sheath 18 can be limited, which reduces commensurately the outside diameter of the optical cable 10.

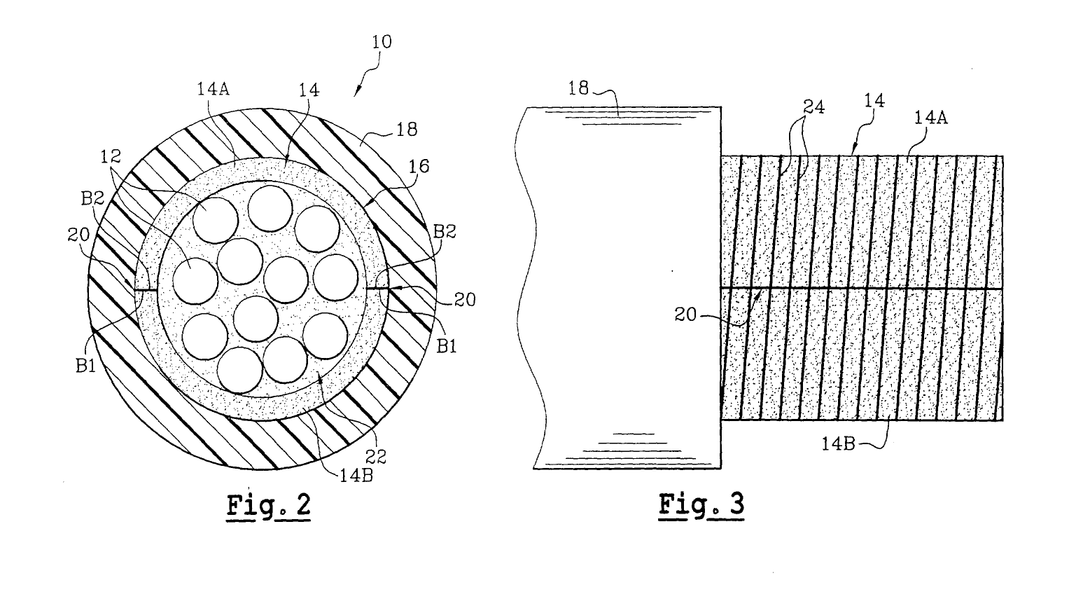

FIGS. 2 and 3 show a second embodiment of an optical cable according to the invention. In these figures, components analogous to those in FIG. 1 are designated by the same reference number.

Here, the strength member 14 comprises two longitudinal half-members 14A, 14B. Each half-member 14A, 14B has edges B1, B2 in contact with the other half-member 14B, 14A. The contacting edges B1, B2 of the two half-members 14A, 14B form contiguous edges delimiting two slots 20 providing access to the optical fibers 12. The edges B1, B2 of the strength member 14 delimiting the two slots 20 are preferably straight.

The two half-members 14A, 14B are held together by means that can be torn or cut, for example a tie 24 wrapped around the strength member 14 (this is known as binding). The tie 24 can be a filament or a tape and is fabricated from polyester, Nylon® or aramide, for example.

One advantage of the invention is that it provides easy access to the optical fibers 12 of the optical cable 10 and thus easy connection of the optical fibers 12.

In the first embodiment of an optical cable according to the invention, the user obtains access to the optical fibers 12 by cutting the sheath 18 in line with the slot 20. The optical fibers 12 can be easily extracted from the strength member 14 through the slot 20.

In the second embodiment of an optical cable according to the invention, the user obtains access to the optical fibers 12 by cutting the sheath 18 and cutting or tearing the tie 24 holding the two half-members 14A, 14B together. The two half-members 14A, 14B can then be spread apart to open one of the slots 20 and provide access to the optical fibers 12 accommodated in the strength member 14.

The invention therefore proposes an optical cable including a relatively small number of optical fibers and having a small diameter but, thanks to the strength member 14, retaining the features usually required of this type of cable, namely good resistance to crushing and traction and low contraction at low temperatures.

It will be noted that the optical cable 10 according to the invention is made from a limited number of components and materials.

Furthermore, the invention provides easy access to the optical fibers 12 of the optical cable 10 by cutting the sheath 18, even in the middle of the cable. The optical fibers 12 can therefore be connected partway along the optical cable 10.

Once the strength member 14 has been at least partly bared, access to the fibers 12 is obtained through the slot 20 without using any tools.

The slot 20 is open, i.e. not stopped up by adhesive or welding.

There is claimed:

1. An optical fiber cable including a sheath, optical fibers accommodated in said sheath, and a substantially annular strength member radially between said optical fibers and said sheath, which strength member has a slot extending in its general longitudinal direction, delimited by separated or contiguous edges of said strength member, and providing access to said optical fibers accommodated in said strength member.

2. The cable claimed in claim 1 wherein said edges of said strength member delimiting said access slot are separated by a distance greater than the diameter of an optical fiber.

3. The cable claimed in claim 1 wherein said strength member comprises two longitudinal half-members each of which has edges in contact with the other half-member, said edges in contact of said half-members forming contiguous edges delimiting two optical fiber access slots.

4. The cable claimed in claim 3 including means for holding said two half-members together and adapted to be torn or cut.

5. The cable claimed in claim 4 wherein said means for holding said two half-members together comprise a tie wrapped around said strength member.

6. The cable claimed in claim 1 wherein said strength member is made from a synthetic material.

7. The cable claimed in claim 6 wherein said synthetic material of said strength member is reinforced with fibers, for example glass fibers, and said synthetic material is a material known as fiber reinforced plastic (FRP) or glassfiber reinforced plastic (GRP).

8. The cable claimed in claim 6 wherein said synthetic material of said strength member is a thermoplastics material.

9. The cable claimed in claim 1 wherein said strength member is made of metal, for example steel.

10. The cable claimed in claim 1 wherein said edges of said strength member delimiting said slot are straight.

11. The cable claimed in claim 1 wherein said edges of said strength member delimiting said access slot have an SZ shape.

12. The cable claimed in claim 1 including a filler material, for example a gel or a powder, accommodated in said strength member.

13. A method of fabricating an optical cable as claimed in claim 1, wherein:
said strength member is fabricated,
said optical fibers are accommodated in said strength member to form an optical assembly comprising said strength member and said optical fibers, and
said sheath is extruded around said optical assembly.

14. The method claimed in claim 13 wherein a filler material is placed in said strength member before extruding said sheath.
